(19) United States
(12) Patent Application Publication
(10) Pub. No.: US 2003/0053836 A1
(43) Pub. Date: Mar. 20, 2003

(54) Mechanical safety interlock and device using the same

(76) Inventors: Sathiyamoorthy Thirunageswaram Sivanandam, Singapore (SG); Baskar Parthasarathy, Singapore (SG); Choon Siang Peck, Singapore (SG)

Correspondence Address: HEWLETT-PACKARD COMPANY, Intellectual Property Administration, P.O. Box 272400, Fort Collins, CO, 80527-2400, US

(21) Appl. No.: 09/955,766

(22) Filed: Sep. 18, 2001

(51) Int. Cl. B41J 13/02

(52) U.S. Cl. 400/679

(57) ABSTRACT

A device having a mechanical safety interlock is disclosed. The device has at least one moveable part contained in a housing. The moveable part is accessible through an opening in the housing. The device includes a cover for covering the opening. The mechanical safety interlock includes an actuator attached to the cover and a mechanical driver supported in the housing adjacent the moveable part. The driver is biased away from the moveable part to a disengaged position to interrupt transmission of mechanical movement from the driver to the moveable part. When the cover is brought to cover the opening, the actuator engages the driver to bring the driver to an engaged position to allow the moveable part to tap mechanical movement of the driver to thereby be driven.

### BACKGROUND

This invention relates, generally, to a mechanical safety interlock and a device using the same. More specifically, this invention relates to a mechanical safety interlock used in a device having hazardous moving parts that are accessible through an opening in a device housing, the movement of the moving parts being responsive to the position of a cover over the opening.

Many electrical devices include moving parts that are hazardous to a user. One such device is a printer that has feed rollers for transporting sheet media. Another such device is a duplexer that is attachable to a printer for receiving a sheet medium from the printer and returning a flip side of the sheet medium to the printer so that the sheet medium can be printed on both its surfaces. The duplexer also has feed rollers similar to those in printers, for transporting the sheet medium. The feed rollers on both the printer and the duplexer are typically made accessible through an opening in a housing. The opening can be covered using a door hinged to the housing or a separate cover. The door is opened or the cover is removed to expose the feed rollers for tasks such as servicing the feed rollers, replacing the feed rollers and clearing sheet media jammed between the feed rollers to be performed.

Detectors such as micro switches and optical sensors are typically used to detect the position of the door or the cover as disclosed in U.S. Pat. No. 5,216,246 and U.S. Pat. No. 5,657,132. The feed rollers are designed to be actuatable only when the door or cover is detected to be in a closed position over the opening.

Although these prior art means work, they suffer from disadvantages. The detectors increase the number of parts in the devices. An additional controller input line is required for sensing each detector. Additional software is also required to poll the detector to sense its status. These detectors therefore add to the material and manufacturing costs of the devices.

### SUMMARY

According to one aspect of the present invention, there is provided a mechanical safety interlock that can be used in a device having at least one moveable part contained in a housing. The moveable part is accessible through an opening in the housing. The device includes a cover for covering the opening. The mechanical safety interlock includes an actuator attached to the cover and a mechanical driver supported in the housing adjacent the moveable part. The driver is biased away from the moveable part to a disengaged position to interrupt transmission of mechanical movement from the driver to the moveable part. When the cover is brought to cover the opening, the actuator engages the driver to bring the driver to an engaged position. In this engaged position, the driver drives the moveable part.

According to another aspect of the present invention, there is provided a device including the above mechanical safety interlock.

### BRIEF DESCRIPTION OF DRAWINGS

The invention will be better understood with reference to the drawings, in which:

FIG. 1 is an isometric drawing of a duplexer including a mechanical safety interlock according to an embodiment of the present invention;

FIG. 2 is an isometric drawing of the mechanical safety interlock in FIG. 1 including a bell crank shown biased to a disengaged position when a cover is removed to expose an opening in the duplexer;

FIG. 3 is an isometric drawing similar to FIG. 2 showing the bell crank in an engaged position when the cover is placed over the opening to cover the opening; and

FIG. 4 is a partial isometric drawing of a mechanical safety interlock according to a second embodiment of the invention.

### DETAILED DESCRIPTION

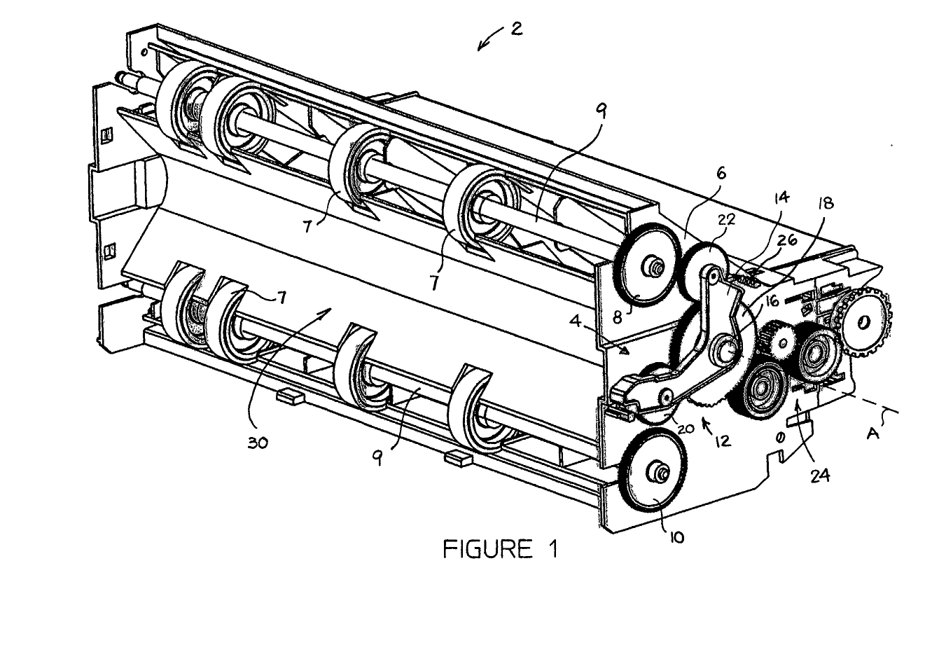

FIG. 1 shows a duplexer 2 that can be attached to a printer (not shown) for receiving a sheet medium from the printer, inverting the sheet medium and returning the sheet medium to the printer for printing. This duplexer 2 includes a mechanical safety interlock 4 according to the present invention. Although the invention is described to be implemented in the duplexer 2, it is to be appreciated that the invention can be readily used in other devices that have moveable parts, which if not properly stopped during servicing, may cause physical injury to a service person.

The duplexer 2 includes a mounting frame 6. The frame 6 supports moveable parts such as feed rollers 7 mounted on feed roller shafts 9. Feed roller gears 8, 10 are fixedly attached to an end of the feed roller shafts 9. A mechanical driver 12 is supported by the frame 6 adjacent the feed roller gears 8, 10. The mechanical driver 12 drives the feed roller gears 8, 10 to rotate the feed rollers 7. The driver 12 includes a lever or bell crank 14 pivotably mounted to the frame 6 along an axis A via a pin 16. Attached to the pin 16 is a drive gear 18 that freely rotates about the axis A. Rotatably attached to the ends of the bell crank 14 are planet gears 20, 22. The planet gears 20, 22 are coupled to the drive gear 18 to be driven by the drive gear 18. The drive gear 18 is coupled to a gear train 24. The gear train 24 is in turn coupled to and driven by a gear (not shown) in an attached printer.

A tension spring 26 is fixedly attached at one end to the bell crank 14 and the other end to the frame 6. The tension spring 26 biases the bell crank 14 to tilt it in a clockwise direction about the pin axis A. The bell crank 14 includes an engagement portion 28 that has an incline 29.

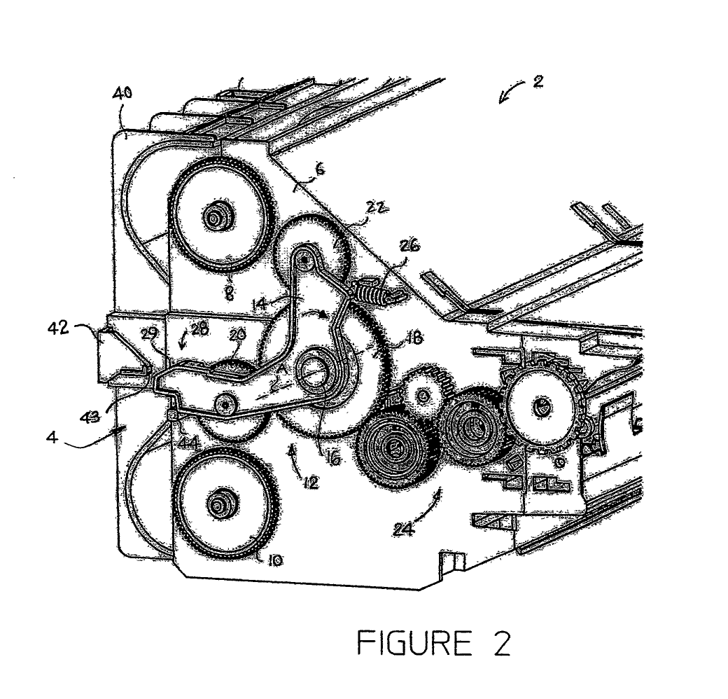

The duplexer 2 includes an opening 30 through which the feed rollers 7 are accessible. The duplexer 2 includes a cover 40 (FIG. 2) for covering the opening 30. Extending from one side of the cover 40 is an actuator 42. The actuator 42 has a rounded edge 43.

When the cover 40 is removed from the opening 30 and moved to an open position as shown in FIG. 2, the tension spring 26 pulls the bell crank 14 to tilt it in the clockwise direction to a disengaged position. In this disengaged position, the planet gears 20, 22 are clear of the feed roller gears 8, 10. Any transmission of rotational movement of the gear train 24 through the drive gear 18 and planet gears 20, 22 to the feed roller gears 8,10 will be interrupted. The feed rollers 7 will therefore remain stationary when the cover 40 is in the open position, posing no threat to a service person.

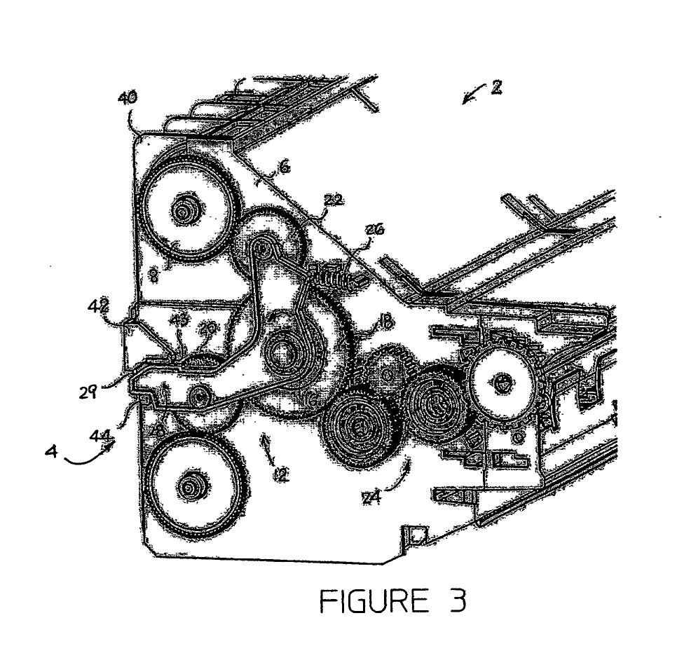

FIG. 3 shows the duplexer 2 with the cover 40 in a closed position covering the opening 30. As the cover 40 is brought towards this closed position, the rounded edge 43 of the actuator 42 comes into contact with the incline 29 of the engagement portion 28 of the bell crank 14. Further moving of the cover 40 to the closed position causes the rounded edge 43 to ride up the incline 29 to tilt the bell crank 14 in the counter clockwise direction. When the cover 40 is in the closed position, the engagement portion 28 comes into contact with a stopper 44 that extends from the frame 6. In this position, the engagement portion 28 becomes sandwiched between the actuator 42 and the stopper 44 so that the bell crank 14 is firmly held in an engaged position. In this engaged position, the planet gears 20, 22 are coupled to the feed roller gears 8,10 to tap rotary movement therefrom. Any rotational movement of the planet gears 20, 22 will be transmitted to the feed roller gears 8,10 to drive the feed rollers 7.

Advantageously, the mechanical safety interlock 4 provides a cost effective solution for stopping the operation of the feed rollers 8,10 in the duplexer 2 when the cover 40 is removed to expose the feed rollers 7. The mechanical safety interlock 4 is also more reliable than those using micro switches and optical sensors.

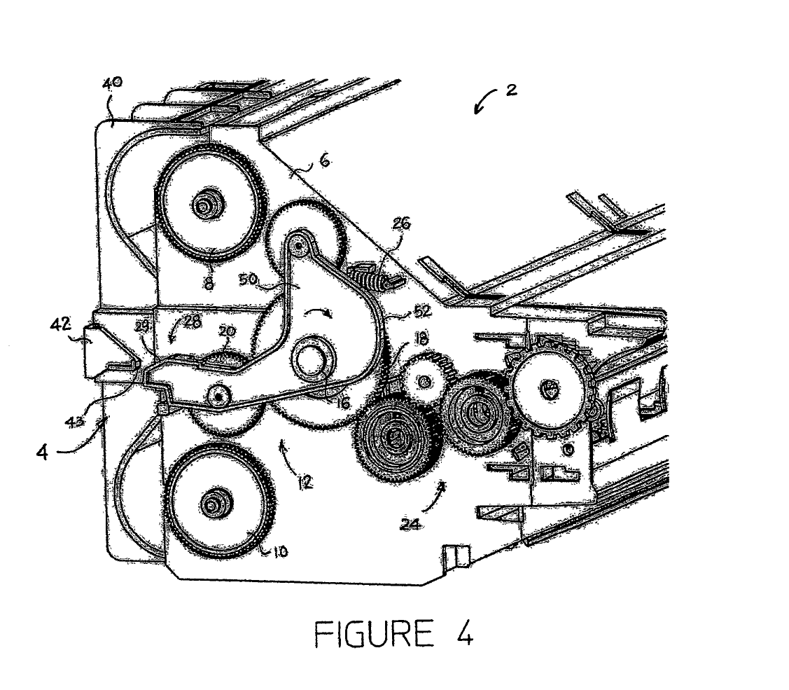

While the present invention has been shown and described with reference to the foregoing operational principles and preferred embodiment, it will be apparent to those skilled in the art that other changes in form and detail may be made. As an example, the bell crank 14 (FIG. 3) requiring the tension spring 26 for biasing the bell crank 14 may be replaced with a bell crank 50 as shown in FIG. 4. The bell crank 50 is made heavier on one side 52 so that the bell crank 50 is gravitationally biased to tilt it in the clockwise direction to a disengaged position.

As another example, the drive gear 18 may be rotatably mounted separately from the bell crank 14.

We claim:

1. A mechanical safety interlock for a device having a moveable part accessible through an opening in a housing, the device includes a cover for covering the opening, the mechanical safety interlock comprising:
an actuator attached to the cover; and
a mechanical driver supported in the housing adjacent the moveable part, the driver being biased away from the moveable part to a disengaged position to interrupt transmission of mechanical movement from the driver to the moveable part;
wherein when the cover is brought to cover the opening, the actuator engages the driver to bring the driver to an engaged position to allow the moveable part to tap mechanical movement of the driver to thereby be driven.

2. A mechanical safety interlock according to claim 1, wherein the moveable part includes a roller gear attached to a roller and wherein the driver includes:
a lever pivotably mounted along an axis;
a drive gear rotatably mounted along the axis adjacent the lever; and
a planet gear rotatably mounted to the lever and coupled with the drive gear;
wherein when the cover is brought to cover the opening, the actuator engages the lever to tilt the lever about the axis to the engaged position to couple the planet gear with the roller gear to thereby transmit rotary movement from the drive gear to the roller gear.

3. A mechanical safety interlock according to claim 2, wherein the lever is heavier at one end for gravitationally biasing the lever to the disengaged position.

4. A mechanical safety interlock according to claim 2, wherein the driver further includes an engagement portion that allows the actuator to engage the lever.

5. A mechanical safety interlock according to claim 4, wherein the engagement portion includes an incline and the actuator includes a rounded edge that rides on the incline when the actuator engages the lever to tilt the lever.

6. A device comprising:
a housing having an opening;
at least one moveable part in the housing and accessible through the opening;
a removeable cover for covering the opening;
an actuator attached to the cover; and
a mechanical driver supported in the housing adjacent the moveable part, the driver being biased away from the moveable part to a disengaged position to interrupt transmission of mechanical movement from the driver to the moveable part;
wherein when the cover is brought to cover the opening, the actuator engages the driver to bring the driver to an engaged position to allow the moveable part to tap mechanical movement of the driver to thereby be driven.

7. A device according to claim 6, wherein the moveable part includes a roller gear attached to a roller and wherein the driver includes:
a lever pivotably mounted along an axis;
a drive gear rotatably mounted along the axis adjacent the lever; and
a planet gear rotatably mounted to the lever and coupled with the drive gear;
wherein when the cover is brought to cover the opening, the actuator engages the lever to tilt the lever about the axis to the engaged position to couple the planet gear with the roller gear to thereby transmit rotary movement from the drive gear to the roller gear.

8. A device according to claim 7, wherein the lever is heavier at one end for gravitationally biasing the lever to the disengaged position.
